(19) United States
(12) Patent Application Publication
(10) Pub. No.: US 2004/0245864 A1
(43) Pub. Date: Dec. 9, 2004

(54) Moving coil transducer

(76) Inventor: Paul Brian Bailey, Oxford (GB)

Correspondence Address: NIXON & VANDERHYE, PC, 1100 N GLEBE ROAD, 8TH FLOOR, ARLINGTON, VA, 22201-4714, US

(21) Appl. No.: 10/494,310

(22) PCT Filed: Oct. 31, 2002
(86) PCT No.: PCT/GB02/04927

(30) Foreign Application Priority Data
Nov. 1, 2001 (GB) 0126285.6

(51) Int. Cl. H04R 9/04; H04R 1/00

(52) U.S. Cl. 310/15; 381/400

(57) ABSTRACT

A moving coil transducer which comprises a yoke, permanent magnet and pole piece which are assembled to form a magnet circuit leaving an air gap between two opposing surfaces of the yoke and pole piece for receiving the moving coil. The permanent magnet is positioned between other opposing surfaces of the yoke and pole piece, and its faces are not parallel. Thus the thickness of the magnet increases away from the air gap of the magnetic circuit. In an annular or toroidal design in which the pole piece, permanent magnet and yoke are all annular and define an annular air gap, the magnet may be of conical form, having a thickness which increases away from the air gap. The pole piece and yoke are correpondingly tapered at the portions which meet the permanent magnet. The use of the non-flat magnet allows more magnetic material to be included in the transducer without increasing the overall volume of the transducer. This results in an increased magnetic flux density in the air gap and thus an increase in power and/or efficiency.

The present invention relates to a moving coil transducer, and in particular to magnetic circuit for use in such a transducer and which increases the efficiency and/or power of such a transducer.

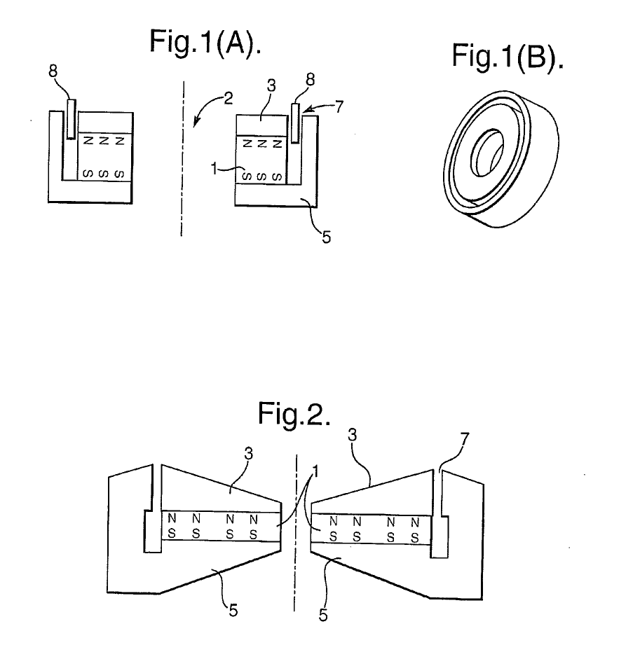

A typical moving coil transducer, such as a voice coil motor or generator, consists of a magnet, yoke and pole piece as shown in cross-section in FIG. 1 of the accompanying drawings. As can be seen there the magnet 1 is in the form of a disk or annulus (the centre hole 2 is optional) which is magnetised axially and positioned between opposed surfaces of a disk or annular pole piece 3 and yoke 5. An air gap 7 is defined between two further opposed surfaces of the pole piece and yoke, and in use a coil 8 is positioned in the air gap. The permanent magnet 1 creates a magnetic flux in the air gap 7 and this flux interacts with the coil either to move the coil in response to an electrical current in the coil (motor) or to create a current in response to movement (generator). The coil moves axially of the assembly; FIG. 1(B) shows the magnetic circuit in perspective.

One application of this type of transducer as a motor is to drive a compressor in a Pulse Tube or Stirling cycle refrigerator, but it also has other applications such as linear alternators or generators, loudspeakers and other actuators or oscillators.

A variation on the conventional design of FIG. 1 is illustrated in FIG. 2. In this variation the yoke and pole piece have been tapered at top and bottom in order to reduce the mass of the assembly and also, in some cases, to reduce stray “fringing” flux in the magnetic circuit. Removing this material from the pole piece and yoke does not have a significant effect oil the flux in the air gap because the removed regions carry only a low magnetic flux density anyway in the magnetic circuit.

While the variation illustrated in FIG. 2 has the effect of reducing the mass of the assembly, it does not increase the power or efficiency of the transducer. The power or efficiency of the transducer can be increased by using a larger magnet, but this would increase the volume of the transducer and this may be undesirable in applications where the volume is a significant consideration (eg. where the transducer must be housed in a very limited space).

According to the present invention there is provided a moving coil transducer comprising a yoke, permanent magnet and a pole piece assembled to form a magnetic circuit, an air gap for receiving the moving coil being defined between first opposed surfaces of the yoke and pole piece, and the permanent magnet being positioned between second opposed surfaces of the yoke and pole piece with its direction of magnetisation parallel to the direction of movement of the moving coil, wherein the surfaces of the permanent magnet facing said second opposed surfaces are not parallel.

The shaping of the magnet in this way allows an increase in the amount of magnet material included in the magnetic circuit, without increasing the overall size of the device. Thus it increases the power and/or efficiency of the device.

The term “coil” is used to indicate the moving electrical conductor in the transducer, but conventionally multiple windings are used in the form of a rotationally symmetrical coil to increase the electromagnetic coupling.

Preferably the thickness of the permanent magnet increases away from the air gap of the magnetic circuit (i.e. towards the outside), for instance the surfaces of the permanent magnet may linearly diverge. The second opposed surfaces of the pole piece and yoke may be correspondingly shaped to contact the surfaces of the permanent magnet, in which case the yoke and/or pole piece are tapered, but on the surface contacting the permanent magnet, rather than the outside surface as in the conventional design of FIG. 2.

Thus with the magnet positioned in the magnetic circuit so that its direction of magnetisation is parallel to the direction of movement of the coil, and at right angles to the direction of magnetic flux in the air gap, one or both of the surfaces of the magnet may be inclined to the direction of magnetic flux in the air gap.

Preferably the yoke, pole piece and permanent magnet are axially symmetrical and co-axially assembled with the yoke surrounding the pole piece to define an annular air gap. In this case the direction of magnetisation of the permanent magnet is axially of the assembly, and the thickness of the permanent magnet increases radially away from the air gap. Thus the permanent magnet may be in the form of an annulus or disk having a top and/or bottom in the shape of a conic frustum, rather than a flat annulus or disk as in the prior art.

The invention may be applied where a double-magnetic circuit is provided, ie. with taco yokes, magnets and pole pieces adjacent to one another axially along the direction of movement, and also where the magnet and pole piece are positioned axially inwardly of the yoke or axially outwardly of the yoke.

The invention will be further described by way of example with reference to the accompanying drawings in which:—

FIG. 1 shows schematically a first conventional moving coil transducer;

FIG. 2 shows schematically a second conventional moving coil transducer;

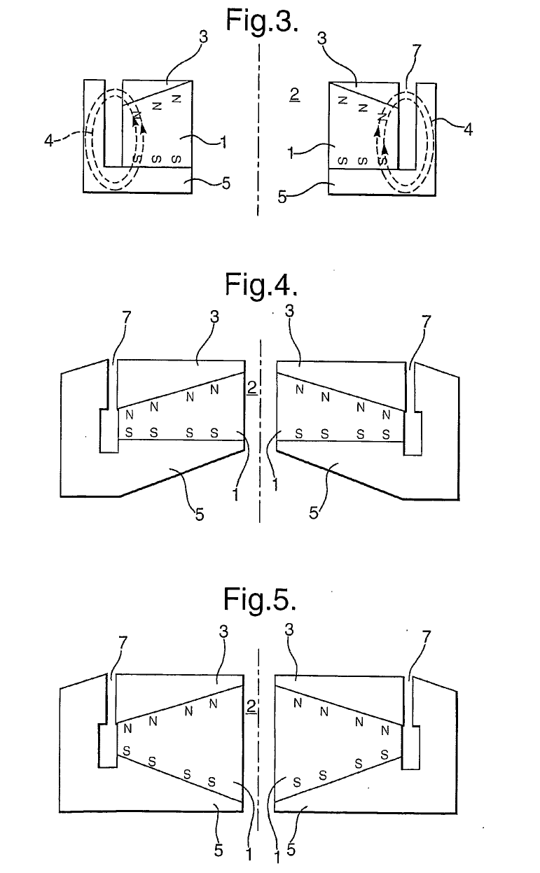

FIG. 3 shows schematically a voice coil transducer according to a first embodiment of the present invention;

FIG. 4 shows schematically a second embodiment of the present invention;

FIG. 5 shows schematically a third embodiment of the present invention;

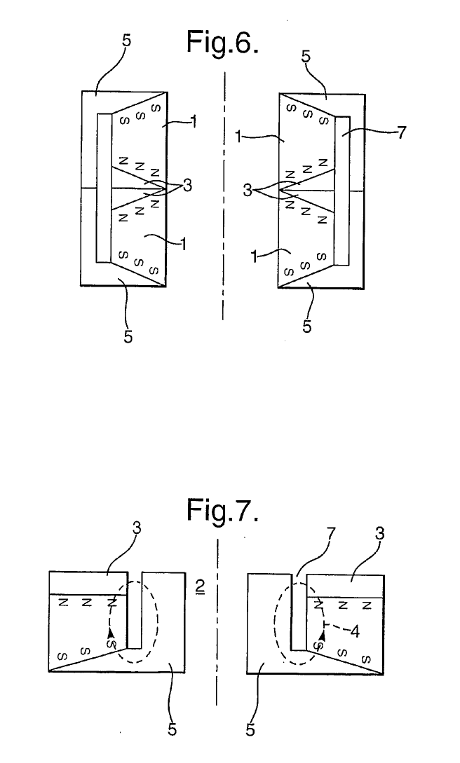

FIG. 6 shows schematically a fourth embodiment of the present invention; and

FIG. 7 shows schematically a fifth embodiment of the present invention.

A first example of the present invention is illustrated schematically in FIG. 3. It consists of a permanent magnet 1, yoke 5 and pole piece 3 which are all axially symmetrical and arranged coaxially together in a similar manner to the conventional transducers of FIGS. 1 and 2 to define an annular air gap 7 in which, in use, the moving coil part of the transducer is received. Thus the yoke, pole piece and permanent magnet form a magnet circuit in which the magnetic flux indicated by dotted lines 4 and generated by the permanent magnet passes through the pole piece 3, the air gap 7 and via the yoke 5 back to the permanent magnet. It will be appreciated that the overall shape of the magnetic circuit is of a toroid or doughnut. As with the conventional transducers, a centre hole 2 may be provided, though this is optional. As illustrated in FIG. 3, and in accordance with the invention, the magnet 1 is not flat as in the prior art. Instead the pole piece 3 is tapered radially inwardly of the transducer so that the thickness of the permanent magnet increases radially inwardly of the transducer. Thus in FIG. 3 the upper face of the permanent magnet diverges from the lower one so that the thickness of the magnet is increased away from the air gap (i.e. towards the outside of the section of the magnetic circuit shown in FIG. 3). Thus without increasing the overall volume of the transducer, more magnetic material is accommodated than with a conventional parallel-faced magnet. This extra material results in an increased flux density in the air gap 7. It is found that the flux density can be increased by, for example, six percent.

FIG. 4 illustrates a second example of the invention in which the magnet 1 is of the same form as shown in FIG. 3, but the lower face of the yoke is tapered in similar fashion to the conventional design of FIG. 2. The transducer of FIG. 4 has the advantages of increased magnetic flux derived from the use of the conical magnet, and also the weight saving and reduction in flinging flux of the tapered yoke.

FIG. 5 illustrates a third example of the invention in which both the upper and lower faces of the magnet are inclined by virtue of both the pole piece 3 and yoke 5 being tapered at the portions which contact the magnet. Thus again the thickness of the magnet increases towards the centre of the transducer, ie. away from the centre of the left and right sections of the magnetic circuit. It will be appreciated that this allows even more magnetic material to be included in the transducer, with no increase in overall volume.

FIG. 6 illustrates a fourth example of the invention in which two sets of magnets, yokes and pole pieces are arranged face to face. The moving coil is, again, accommodated in the air gap 7, for instance by means of a spider-like support.

FIG. 7 illustrates a fifth example of the invention in which the components of the magnetic circuit are rearranged so that the yoke is on the inside and the magnet and pole piece around the outside of the air gap 7. Again the surfaces of the permanent magnet are not parallel, in this case the surface contacting the yoke is inclined so that the thickness of the magnet increases away from the air gap of the magnetic circuit.

The transducers according to the invention are useful in the same range of appliances as conventional transducers, but offer increased flux density and thus increased power without any increase in size. For example, in the use of such a transducer as a linear motor for a Stirling cycle compressor for a particular application there is a need for 60 Watts of shaft power but only limited space available for the motor (which must be of maximum diameter 100 mm) and a desire for minimal electrical power input to the motor (ie. the highest possible efficiency). Using a neodymium-boron-iron magnet, a cobalt-iron yoke and mild steel pole piece, the conventional design of motor using an annular flat magnet gives a mean flux density in the air gap of 0.86 Tesla, and when delivering 60 Watts of shaft power, the input power to the motor is 70.5 Watts. Using one, face of the magnet coned, with a mating cone on the pole piece, improves the air gap flux density to 0.91 Tesla, and for the same 60 Watts of shaft power only requires an input power of 69.4 Watts. If both faces of the magnet are coned, with corresponding mating cones in the pole piece and yoke, this farther increases the flux density in the air gap to 0.955 Tesla, meaning that a shaft power of 60 Watts can be delivered within an input power of only 68.5 Watts.

1. A moving coil transducer comprising a yoke, permanent magnet and a pole piece assembled to form a magnetic circuit, an air gap for receiving the moving coil being defined between first opposed surfaces of the yoke and pole piece, and the permanent magnet being positioned between second opposed surfaces of the yoke and pole piece with its direction of magnetisation substantially parallel to the direction of movement of the moving coil, wherein the surfaces of the permanent magnet facing said second opposed surfaces are not parallel.

2. A moving coil transducer according to claim 1 wherein the thickness of the permanent magnet increases away from the air gap of the magnetic circuit.

3. A moving coil transducer according to claim 1 wherein both of said surfaces of the permanent magnet linearly diverge away from the air gap of the magnetic circuit.

4. A moving coil transducer according to claim 1 wherein the second opposed surfaces of the pole piece and yoke are correspondingly shaped to contact the surfaces of the permanent magnet.

5. A moving coil transducer according to claim 1 4 wherein the permanent magnet has one surface substantially perpendicular to the direction of movement of the moving coil and one surface inclined to the direction of movement.

6. A moving coil transducer according to claim 1 wherein the yoke, pole piece and permanent magnet are axially symmetrical and coaxially assembled with the yoke surrounding the pole piece to define an annular air gap, the direction of magnetisation of the permanent magnet being axially of the assembly, and the thickness of the permanent magnet increasing radially inwardly of the assembly.

7. A moving coil transducer according to claim 1 wherein the yoke, pole piece and permanent magnet are axially symmetrical and coaxially assembled with the yoke positioned radially inwardly of the permanent magnet and pole piece, so that the pole piece surrounds the outside of an annular air gap and an opposing face of the pole piece is on the inside of the annular air gap, the direction of magnetisation of the permanent magnet being axially of the assembly, and the thickness of the permanent magnet increasing radially outwardly of the assembly.

8. A moving coil transducer according to claim 6 wherein the permanent magnet is an annulus or disk having a top and/or bottom in the shape of a conic frustum.

9. A moving coil transducer according to claim 1 wherein at least one of said yoke and pole piece is tapered at said second surface.

10. A moving coil transducer according to claim 9 wherein the permanent magnet has a corresponding shape to mate closely with said second surfaces.

11. A moving coil transducer comprising two separate magnetic circuits, each in accordance with that defined in claim 1, positioned adjacent one another in the direction of motion of the moving coil, with their respective yokes, pole pieces and air gaps adjacent each other.

12 (canceled)
